(19) United States
(12) Patent Application Publication
(10) Pub. No.: US 2024/0046217 A1
(43) Pub. Date: Feb. 8, 2024

(54) TALENT MOBILITY PLATFORM

(71) Applicant: ADP, Inc., Roseland, NJ (US)

(72) Inventor: Jyotsna MANIKANTAN, Edison, NJ (US)

(21) Appl. No.: 17/881,865

(22) Filed: Aug. 5, 2022

(51) Int. Cl. G06Q 10/10; G09B 19/00

(52) U.S. Cl. CPC G06Q 10/1053; G09B 19/00

(57) ABSTRACT

The present disclosure relates generally to tools to determine workforce talent and, more particularly, to a system, method and computer program product to provide a platform for talent mobility within an organization. The method includes: scanning, by a computer system, disparate computing systems to obtain information of employees from within an organization; obtaining, by the computer system, at least one open job position within the organization and associated job information; identifying, by the computer system, a qualified candidate from the employees from within the organization for the at least one open job position by comparing the information of the employees to the job information associated with the at least one open job position; and providing, by the computer system, notification to the qualified candidate that at least one open job position is available.

### TECHNICAL FIELD

The present disclosure relates generally to tools to determine workforce talent and, more particularly, to a system, method and computer program product to provide a platform for talent mobility within an organization.

### BACKGROUND

There are many missed opportunities within an organization to promote their own qualified employees for open positions. For example, there are many instances in which a talented internal employee is not considered and, in fact, may be excluded from posted open positions due to a hiring process that neglects to consider internal candidates and, instead, promotes the idea of a hiring process that looks for employees outside of the organization. This type of hiring practice can be expensive, time consuming and, in many instances, fails to focus on the growth of an organization's own employees. With this noted, employees may not get the necessary support to create meaningful growth within their own organization, leading to dissatisfied employees, who eventually leave the company for different employment and growth opportunities.

### SUMMARY

In a first aspect of the present disclosure, a method includes: scanning, by a computer system, disparate computing systems to obtain information of employees from within an organization; obtaining, by the computer system, at least one open job position within the organization and associated job information; identifying, by the computer system, a qualified candidate from the employees from within the organization for the at least one open job position by comparing the information of the employees to the job information associated with the at least one open job position; and providing, by the computer system, notification to the qualified candidate that at least one open job position is available.

In another aspect of the present disclosure, there is a computer program product comprising one or more computer readable storage media having program instructions collectively stored on the one or more computer readable storage media. The program instructions are executable to: extract employee data from disparate internal systems of an organization including at least current pay grade; obtain posted, open positions within an organization including pay grade of the posted, open positions; compare the extracted employee data to the posted, open positions to determine which employees qualify for any of the posted, open positions, including which employees have a pay grade that is at or below the pay grade of the posted, open positions; identify an employee who is qualified for at least one of the posted, open positions, and who has a pay grade at or below the pay grade of the at least one of the posted, open positions; notify the identified employee that they qualify for the at least one of the posted, open positions; and set up an interview with at least one of the identified employee and an individual that posted the open position by pre-scanning their calendars.

In a further aspect of the present disclosure, a system includes: an employee driven talent activation module, the employee driven talent activation module includes employee entered information comprising aspirations or goals of the employee and skill sets of the employee; and a talent acquisition module that extracts and aggregates employee information and job postings from disparate systems within an organization including the employee driven talent activation module, the talent acquisition module includes a processor, a computer readable memory, one or more computer readable storage media, and program instructions collectively stored on the one or more computer readable storage media, the program instructions executable to determine which employees are qualified candidates to fill an open position based on a comparison between the employee information and the job postings and to provide a notification to the qualified candidates about the open position.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 is an illustrative architecture of a computing system implemented in embodiments of the present disclosure.

FIG. 2 shows an exemplary cloud computing environment in accordance with aspects of the present disclosure.

FIG. 3 shows a block diagram in accordance with aspects of the present disclosure.

FIGS. 4 and 5 depict exemplary flows for a process in accordance with aspects of the present disclosure.

### DETAILED DESCRIPTION OF ASPECTS OF THE INVENTION

The present disclosure relates generally to tools to determine workforce talent and, more particularly, to a system, method and computer program product (hereinafter also referred to as “tools”) to provide a platform for talent mobility within an organization. More specifically, the tools provided herein are configured such that an organization can now look to qualified internal candidates to fill open positions within the organization. These internal candidates can be from within or outside of any department within the organization that is looking to fill an open position. Advantageously, the tools provide a holistic approach in tying together the interest, intent, and information needed to determine and attract internal candidates to open positions within an organization. This holistic approach provides the support to the employees while ensuring human resource business processes remain intact. In addition, the tools provide the focus to retain and retrain employees.

In more specific embodiments, the tools provide a technical solution to a technical problem of hiring qualified candidates from within an organization to fill open positions. The tools provide a platform for the employee to determine which positions are open, in addition to allowing the organization to determine which candidates may be qualified for specific, open positions, internally. This may be accomplished by using a digital self-service platform which connects essential people in a time-bound workflow to fill open positions from within the organization. For example, the tools provided herein may aggregate data from disparate systems regarding a plurality of factors associated with open positions, including employee qualifications, pay, grade, current job responsibilities, etc., perform analysis on the data using machine learning and/or neural network computing to construct a list of internal candidates that meet the qualifications for the open position and provide notifications, reports and recommendations to managers or human resource personnel. The reports may include recommendations of qualified candidates that may be appropriate for filling the open position from within the organization. Notifications can also be provided to individuals within the organization that may qualify for certain open positions.

For example, the tools provided herein are configured to and are capable of providing the following functionality on a computing infrastructure, system, or computer program product (e.g., software product):
(i) scan open positions posted within the organization and determine which potential candidates are at the same pay grade or below of the open position to determine whether they may be eligible for the open position;
(ii) compute a pay difference for the same grade and next grades;
(iii) determine geographic location proximity of an employee that may be qualified for an open position and identify only those employees that are within a certain proximity to the listed job opening for notification;
(iv) send notifications, e.g., email, text, etc., with appropriate information (e.g., name and contact information of hiring manager, etc.) to employees that may be interested in and qualified for the open position;
(v) send notifications, e.g., email, text, etc., with appropriate information (e.g., name and contact information of interested employee, etc.) to hiring managers of qualified candidates (which may be interested in the open position);
(vi) pre-scan availability and set up meetings between the interested parties;
(vii) provide follow up notifications requesting whether both parties remain interested (e.g., confirm Interest to proceed);
(viii) identify skill gaps between the interested employee and requirements for the new role;
(ix) provide links to available and approved on-demand learning platforms for the employee candidate to find courses to upskill or reskill, with both the manager and hiring manager being provided with notifications of the employee's progress of upskilling or reskilling;
(x) provide options for a formal start date in the new role and automated guidance to transition responsibilities to minimize disruption;
(xi) automatically create a new open position for the position which is vacated by the employee leaving their position for the new position; and/or
(xii) automatically update the core team and the different systems to complete the transition and transfer.

Implementations of the present disclosure may be a computer system, a computer-implemented method, and/or a computer program product. The computer program product is not a transitory signal per se, and may include a computer readable storage medium (or media) having computer readable program instructions thereon for causing a processor to carry out aspects of the present disclosure. As described herein, the computer readable storage medium (or media) is a tangible storage medium (or media). It should also be understood by those of skill in the art that the terms media and medium are used interchangeable for both a plural and singular instance.

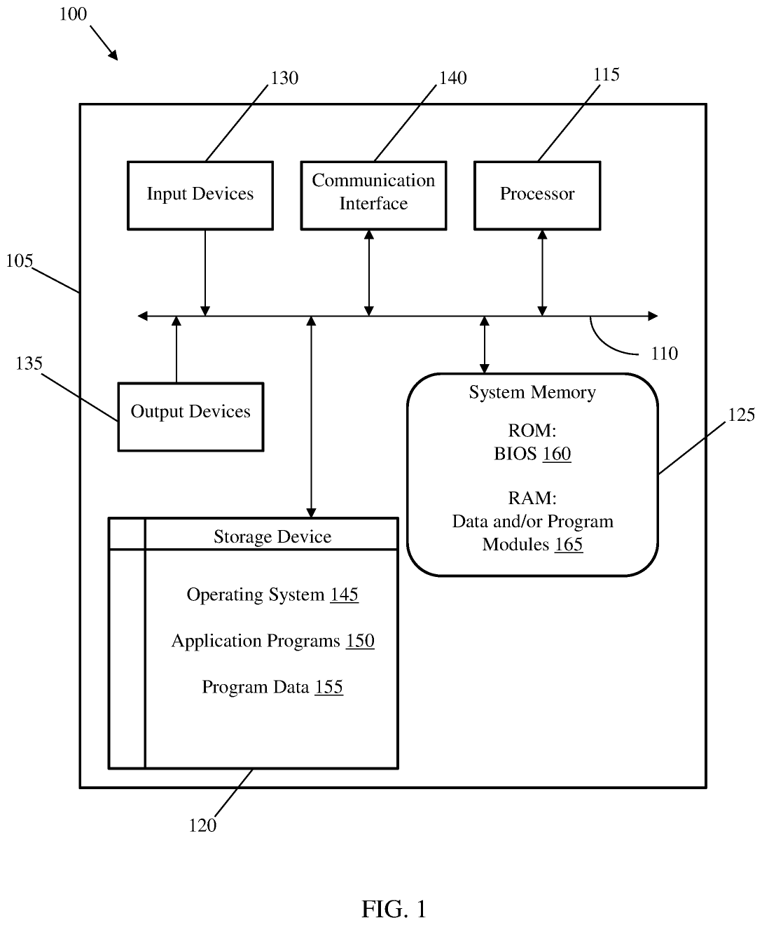

FIG. 1 is an illustrative architecture of a computing system 100 implemented in embodiments of the present disclosure. The computing system 100 is only one example of a suitable computing system and is not intended to suggest any limitation as to the scope of use or functionality of the disclosure. Also, computing system 100 should not be interpreted as having any dependency or requirement relating to any one or combination of components illustrated in computing system 100.

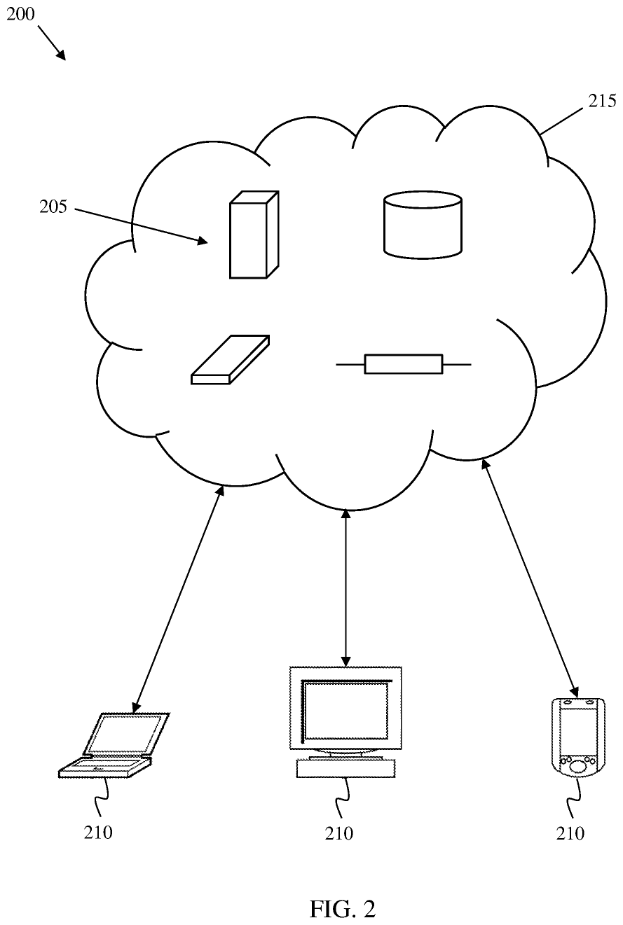

As shown in FIG. 1, computing system 100 includes a computing device 105. The computing device 105 can be resident on a network infrastructure such as within a cloud environment as shown in FIG. 2, or may be a separate independent computing device (e.g., a computing device of a third party service provider). The computing device 105 may include a bus 110, a processor 115, a storage device 120, a system memory (hardware device) 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more processors or microprocessors that include any processing circuitry operative to interpret and execute computer readable program instructions, such as program instructions for controlling the operation and performance of one or more of the various other components of computing device 105. In embodiments, processor 115 interprets and executes the processes, steps, functions, and/or operations of the present disclosure, which may be operatively implemented by the computer readable program instructions.

For example, processor 115 enables the computing device 105 to identify qualified employees for a posted, open position within the organization. This may include, for example, determining employees' current job responsibilities, current pay grade, etc., and comparing these factors to the requirements of the open position. In embodiments, all departments and employees within the organization may automatically be included as processor 115 has the ability to scan all disparate internal systems as described herein. The processor 115 further automatically indexes all open and newly posted positions by geography, business unit, job type, etc. This will allow employees and/or the processes to focus on only certain individuals that are, for example, within a certain geographic location, within or interested in joining a certain business unit, etc. The processor 115 may select employees that meet the criteria/requirements of the posted, open position and notify such employees that they qualify for such position. This may be based on, e.g., pay grade, geography, job type or other requirements. For example, the processer 115 may select an eligible employee that is at or below the pay grade of the open position, and within a certain geographic location and has experience within or posted interest or aspiration to join a certain business unit.

The processor 115 may also notify human resources and hiring managers of such internal candidate that is qualified for and, perhaps, interested in the open position. The processor 115 may also provide the qualified candidate with the pay scale for such open position. Upon interest, the processor 115 may provide the appropriate notifications to all parties of interest, set up appointments and, upon hiring of the internal candidate, update the disparate systems within the organization of such new hire. These updates may include human resources' systems, payroll systems, benefits systems, departmental systems noting core team members and responsibilities, etc.

In this way, the tools provided herein provide an easy to use internal mobility portal that encourages exploration to learn another part of the business, drive interest of internal candidates, and enable easy movement within the organization whether it be lateral movement of upward mobility. The tools also provide a hiring manager with the ability to fill critical roles with an internal candidate quickly and cost effectively. The tools can also provide learning opportunities for those candidates that want to upskill and reskill to gain additional exposures as needed to support future opportunities, while also making pay scales for particular job opportunities more transparent, i.e., allow the employees to know the compensation differences for lateral moves (same grade) vs next grade, etc. The tools further encourage internal talent growth and to build networking relationships, and importantly establishes a talent mobility visibility path in real-time, while building pay-transparency with time-bound transition, automatic notifications of the change to pay, human resources and benefits systems.

As to cost savings, the processes described herein using the tools:
(i) eliminate the need for external job postings and the costs associated with the full-time employees in talent recruiting;
(ii) eliminate the costs of time delay of hiring external candidates, including the cost associated with external candidates requiring additional time to learn the internal machinations, hierarchy, power structure, etc., of the organization;
(iii) eliminate the need for intake of new employees within the organization;
(iv) provide cost savings towards retention of employees and reduction in turnover by enabling growth mobility; and
(v) reduce time to hire and fill a critical role quickly.

In embodiments, processor 115 may receive input signals from one or more input devices 130 and/or drive output signals through one or more output devices 135. The input devices 130 may be, for example, a keyboard, touch sensitive user interface (UI), etc., as is known to those of skill in the art such that no further description is required for a complete understanding of the present disclosure. The output devices 135 can be, for example, any display device, printer, etc., as is known to those of skill in the art such that no further description is required for a complete understanding of the present disclosure.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present disclosure. In embodiments, storage device 120 may store operating system 145, application programs 150, and program data 155 in accordance with aspects of the present disclosure.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computing system 100 may be configured to promote internal mobility within an organization. In particular, computing device 105 may perform tasks (e.g., process, steps, methods and/or functionality) in response to processor 115 executing program instructions contained in a computer readable medium, such as system memory 125. The program instructions may be read into system memory 125 from another computer readable medium, such as data storage device 120, or from another device via the communication interface 140 or server within or outside of a cloud environment. In embodiments, an operator may interact with computing device 105 via the one or more input devices 130 and/or the one or more output devices 135 to facilitate performance of the tasks and/or realize the end results of such tasks in accordance with aspects of the present disclosure. In additional or alternative embodiments, hardwired circuitry may be used in place of or in combination with the program instructions to implement the tasks, e.g., steps, methods and/or functionality, consistent with the different aspects of the present disclosure. Thus, the steps, methods and/or functionality disclosed herein can be implemented in any combination of hardware circuitry and software.

FIG. 2 shows an exemplary cloud computing environment 200 in accordance with aspects of the disclosure. Cloud computing is a computing model that enables convenient, on-demand network access to a shared pool of configurable computing resources, e.g., networks, servers, processing, storage, applications, and services, which can be provisioned and released rapidly, dynamically, and with minimal management efforts and/or interaction with the service provider. In embodiments, one or more aspects, functions and/or processes described herein may be performed and/or provided via cloud computing environment 200.

As depicted in FIG. 2, cloud computing environment 200 includes cloud resources 205 that are made available to client devices 210 via a network 215, such as the Internet. Cloud resources 205 can include a variety of hardware and/or software computing resources, such as servers, databases, storage, networks, applications, and platforms. Cloud resources 205 may be on a single network or a distributed network. Cloud resources 205 may be distributed across multiple cloud computing systems and/or individual network enabled computing devices. Client devices 210 may comprise any suitable type of network-enabled computing device, such as servers, desktop computers, laptop computers, handheld computers (e.g., smartphones, tablet computers), set top boxes, and network-enabled hard drives. Cloud resources 205 are typically provided and maintained by a service provider so that a client does not need to maintain resources on a local client device 210. In embodiments, cloud resources 205 may include one or more computing system 100 of FIG. 1 that is specifically adapted to perform one or more of the functions and/or processes described herein.

Cloud computing environment 200 may be configured such that cloud resources 205 provide computing resources to client devices 210 through a variety of service models, such as Software as a Service (SaaS), Platforms as a service (PaaS), Infrastructure as a Service (IaaS), and/or any other cloud service models. Cloud resources 205 may be configured, in some cases, to provide multiple service models to a client device 210. For example, cloud resources 205 can provide both SaaS and IaaS to a client device 210. Cloud resources 205 may be configured, in some cases, to provide different service models to different client devices 210. For example, cloud resources 205 can provide SaaS to a first client device 210 and PaaS to a second client device 210.

Cloud computing environment 200 may be configured such that cloud resources 205 provide computing resources to client devices 210 through a variety of deployment models, such as public, private, community, hybrid, and/or any other cloud deployment model. Cloud resources 205 may be configured, in some cases, to support multiple deployment models. For example, cloud resources 205 can provide one set of computing resources through a public deployment model and another set of computing resources through a private deployment model.

In embodiments, software and/or hardware that performs one or more of the aspects, functions and/or processes described herein may be accessed and/or utilized by a client (e.g., an enterprise or an end user) as one or more of a SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 and/or performing tasks associated with cloud resources 205. The UI can be accessed via a client device 210 in communication with cloud resources 205. The UI can be configured to operate in a variety of client modes, including a fat client mode, a thin client mode, or a hybrid client mode, depending on the storage and processing capabilities of cloud resources 205 and/or client device 210. Therefore, a UI can be implemented as a standalone application operating at the client device in some embodiments. In other embodiments, a web browser-based portal can be used to provide the UI. Any other configuration to access cloud resources 205 can also be used in various implementations.

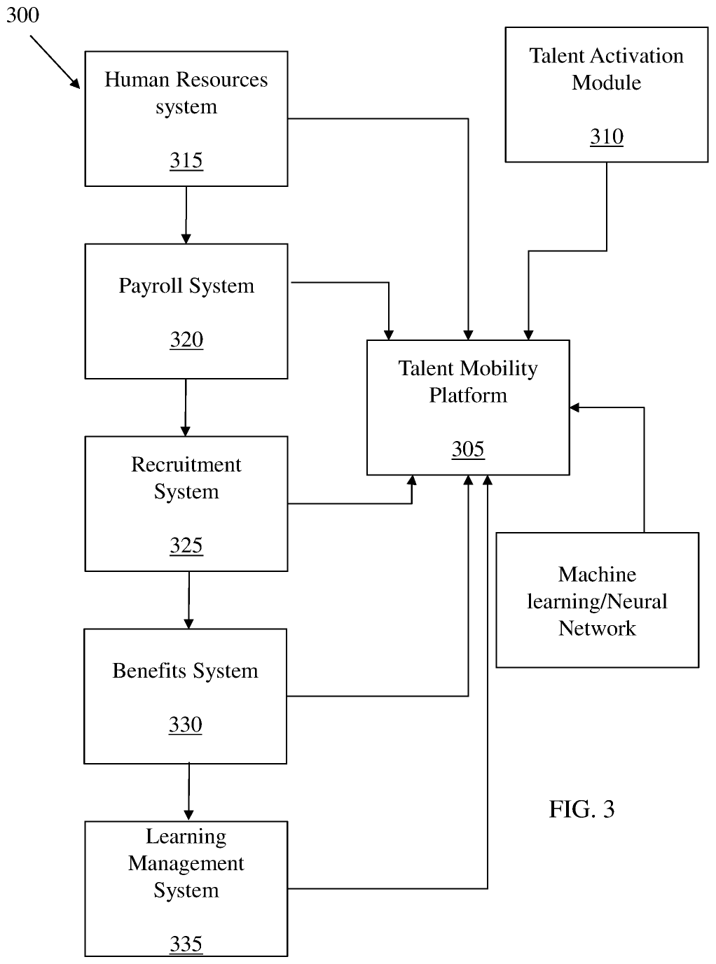

FIG. 3 shows a block diagram in accordance with aspects of the present disclosure. More specifically, FIG. 3 shows a functional block diagram 300 that illustrates functionality of aspects of the present disclosure. In embodiments, the tool(s) comprises a talent mobility platform (digital self-service platform) 305 and talent activation module 310, each of which may comprise one or more program modules such as program modules 165 described with respect to FIG. 1. The tool(s) may include additional or fewer modules than those shown in FIG. 3. In embodiments, separate modules may be integrated into a single module. Additionally, or alternatively, a single module may be implemented as multiple modules. Moreover, the quantity of devices and/or networks in the environment is not limited to what is shown in FIG. 3. In practice, the environment may include additional devices and/or networks; fewer devices and/or networks; different devices and/or networks; or differently arranged devices and/or networks than illustrated in FIG. 3.

In embodiments, the talent mobility platform 305 may be a talent acquisition module (TAS) that retrieves (scans) employee information and job postings from disparate systems to determine which employees may be appropriate candidates for an open position based on, e.g., pay scale, grade, location, intent/aspirations of the employee, and/or qualifications. These disparate systems may include, e.g., human resources system 315, payroll system 320, recruitment system 325, benefits system 330, and learning management system 335, amongst others. In embodiments, the talent mobility platform 305 may also compute a pay difference for the same grade move and next grades, as examples. In addition, based on the information retrieved, the talent mobility platform 305 may determine geographic location proximity of an employee that may be qualified for an open position with the department information and the hiring manager.

In embodiments, the human resources system 315 may include information about employees of the organization including, e.g., name, address, job title and description, manager, location of job and residence, etc. The payroll system 325 may include, e.g., pay grade of employees, bonuses, pay cycles and tax compliance. The recruitment system 325 may include information on job openings, e.g., job title, job description, pay packages (salary and bonuses), location, required qualifications, grade, etc. The recruitment system 325 may include immediate needs or future opportunities as posted by a hiring manager, for example. The benefits system 330 may include benefits of the employees, e.g., stock options, retirement plans, health benefits, in addition to other benefits based on the grade of the employee. The learning management system 335 offers learning modules and can track employee's learning activity. In embodiments, employees can also add/link any external knowledge certifications/credentials with the learning management system 335.

In embodiments, the talent activation module 310 may be an employee driven module. For example, the talent activation module 310 may include employee information (e.g., name, etc.), aspirations of the employees, goals of the employees, preferred job locations, etc. The talent mobility platform 305 may use (e.g., extract) information from the talent activation module 310 and the systems 315-335 to determine whether there are any qualified individuals within the organization that may meet the criteria for a job positing.

By way of illustrative example, using machine learning and/or neutral networking, it is possible to data mine the different systems and determine which employees may be qualified for an open position as listed, for example, in the recruitment system 325. This may include determining, e.g., (i) which employees are at or below the paygrade of the open position, (ii) which employees' qualifications match best with the posted qualifications or job title, (iii) which employees may be interested in the posted job opening, (iv) which employees' aspirations match to the posted job opening, etc.

The talent mobility platform 305 may send notifications, e.g., email, text, etc., with appropriate information (e.g., name and contact information of hiring manager, etc.) to employees that may be interested in and qualified for the open position. Additionally, the talent mobility platform 305 may send notifications, e.g., email, text, etc., with appropriate information (e.g., name and contact information of interested employee, etc.) to managers of qualified candidates (which may be interested in the open position). Moreover, it is contemplated that broadcast messages may be provided to employees, notifying them of open positions. The talent mobility platform 305 can also be automatically schedule appointments by pre-scanning calendars of the interested parties in the hiring process.

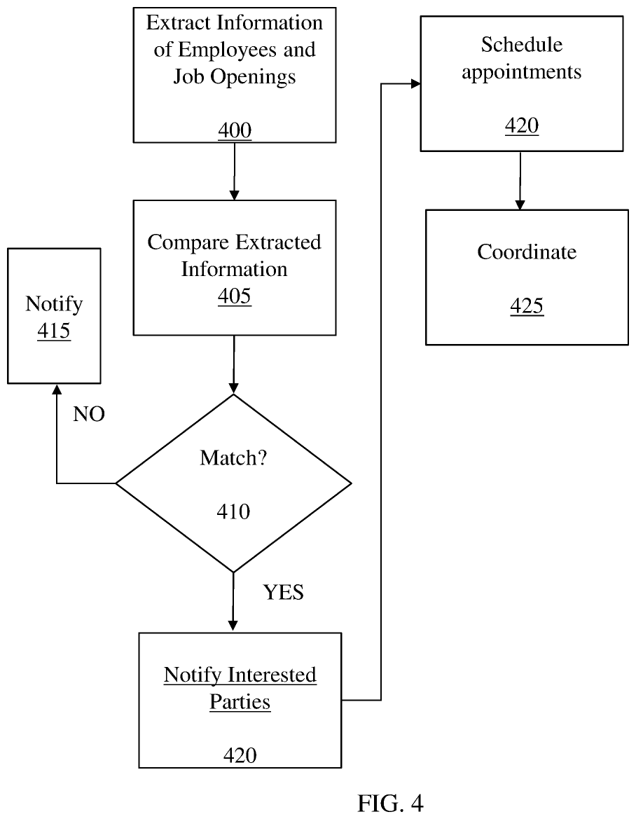

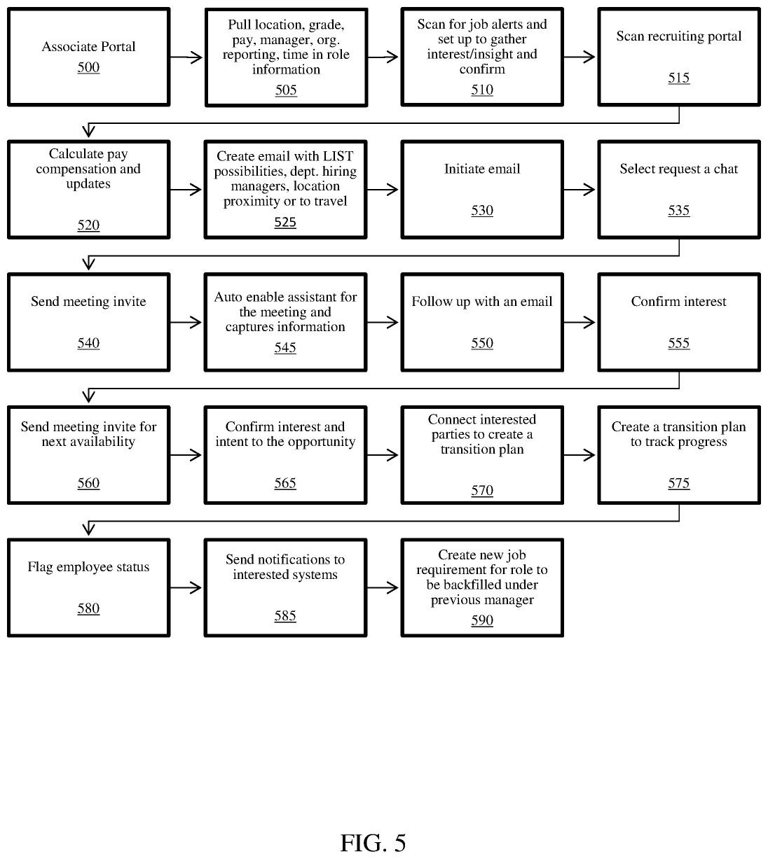

FIGS. 4 and 5 depict exemplary flows for processes in accordance with aspects of the present disclosure. The exemplary flows can be illustrative of a system, a method, and/or a computer program product and related functionality implemented on the computing system of FIG. 1, in accordance with aspects of the present disclosure. The computer program product may include computer readable program instructions stored on computer readable storage medium (or media). The computer readable storage medium may include the one or more storage medium as described with regard to FIG. 1, e.g., non-transitory media, a tangible device, etc. The method, and/or computer program product implementing the flows of FIGS. 4 and 5 can be downloaded to respective computing/processing devices, e.g., computing system of FIG. 1 as already described herein, or implemented on a cloud infrastructure as described with regard to FIG. 2. Accordingly, the processes associated with each flow of the present disclosure can be implemented by special purpose hardware-based systems that perform the specified functions or acts or carry out combinations of special purpose hardware and computer instructions.

More specifically, in FIG. 4, at step 400, information is extracted (e.g., scanned) from the disparate systems, including employee information and posted job information. This information may include any of the information provided in FIG. 3, for example. At step 405, the extracted information is compared, e.g., the posted job information is compared to the employee information. At step 410, a determination is made as to whether there is a match between a qualified employee and the job posting. If no match is found, the system and process will notify interested persons, e.g., human resources, hiring manager, etc., that there is no match internally within the organization for the job posting. This notification may also include providing links to employees of available and approved on-demand learning platforms to find courses to upskill or reskill using, for example, the learning management system. In this way, the process can identify skill gaps between the interested employee and requirements for the posted position, and assist the employee in obtaining the required skills to apply for the position.

If a match is found, all of the interested parties can be notified at step 420. The notification can include a direct notification to an employee that may be qualified for the posted job opening. This notification may include pay scale, job description, location of job, manager, etc., to allow the candidate an opportunity to determine if they are interested in the position. The notification can alternatively or additionally be directed to the hiring manager indicating that a potential match has been found for the open job position. In this case, the notification may include the name of employee and their qualifications, which allows the hiring manager to prescreen candidates.

Should the parties be interested in discussing opportunities, the system and process will schedule appointments at step 420 by pre-scanning calendars to coordinate available times for an interview. At step 425, the process may coordinate the transition to the new position, should it be offered and accepted by the employee. This may include, for example, providing options for formal start date in the new role and automated guidance to transition responsibilities to minimize disruption. In addition, a new listing of the now vacant job can be posted, with a notification to human resources of the newly accepted position, etc. In this way, the processes automatically update the core team and the different systems to complete the transition and transfer.

FIG. 5 depicts a more specific exemplary flow for processes in accordance with aspects of the present disclosure. At step 500, the employee can log into their account. This allows the employee to see if there are any new job postings and the particulars of such postings, e.g., pay, etc. At step 505, the process pulls location, pay grade, manager of open position, organization reporting, and time enrolled information from an appropriate system as described herein.

At step 510, the process scans for any job alerts and sets up to gather interest insight and confirms such through notifications, e.g., Webex notification. At step 515, the process scans the recruiting portal (e.g., recruitment system 325) for open positions at the same pay grade, next pay grade and skipped grade. At step 520, the process calculates pay compensation of updates for the different pay grades. This may include calculating additional benefits or bonuses based on a pay grade. At step 525, the process creates a notification, e.g., e-mail, text, etc., with list possibilities (employees qualified for the position), department hiring managers, location, proximity or travel requirements. At step 530, the process initiates the notification, e.g., e-mail, text, etc. This notification may be sent to the employee of interest, with a copy to the manager and link to a chat. At step 535, the employee selects a request for chat.

At step 540, the process sends a meeting invite for next availability for the employee and hiring manager. At step 545, the process enables a Webex or other similar assistant for the meeting, which allows information to be captured such as notes, highlights and action items. At step 550, the process follows up with another notification, e.g., e-mail, text, etc., to all interested parties to either confirm interest or thank them for their interest.

At step 555, the process confirms interest of both the employee and the hiring manager. At step 560, the process sends a meeting invite for the next availability for the employee and current manager that requirement fulfillment of the job opening. This meeting invite may include information about any gaps and a path forward. At step 565, the employee confirms interest and intent to seek out the opportunity.

If the employee accepts the position, at step 570, the process connects the interested parties to create a transition plan. The interested parties may include, e.g., employee, current manager, hiring manager, and human resources. At step 575, the process creates a transition plan which can be posted into the employee portal, as well as within other systems such as the human resources system. This allows the interested parties to track progress on learning links, to address gaps, transition plans and checkpoints to the conclusion of the transition.

At step 580, the process flags the employee status. This may include transition progress and follow up reminders to transition to new role on a set date. At step 585, the process sends updated notifications to the required systems. These required systems may include payroll system, human resources system, benefits system in order for them to be updated with the employee records. At step 595, the process creates a new job requirements for the roll to be backfilled under the previous manager. This may include grade, location, pay and compensation.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A method, comprising:
scanning, by a computer system, disparate computing systems to obtain information of employees from within an organization;
obtaining, by the computer system, at least one open job position within the organization and associated job information;
identifying, by the computer system, a qualified candidate from the employees within the organization for the at least one open job position by comparing the information of the employees to the job information associated with the at least one open job position; and
providing, by the computer system, notification to the qualified candidate that at least one open job position is available.

2. The method of claim 1, further comprising aggregating the obtained information for the employees including at least pay grade and current skills, and the comparing comprises performing analysis using machine learning and/or neural network computing to construct a list of internal candidates that meet qualifications for the at least one open job position based on the obtained information of the employees.

3. The method of claim 2, wherein the information of the employees include employee driven data including aspirations of the employees.

4. The method of claim 1, further comprising determining pay grade of the employees and pay grade of the at least one open job position, and the identifying includes only the employees that are at or below the pay grade of the at least one open job position.

5. The method of claim 4, wherein the notification is provided to the qualified candidates with a pay grade at or below the pay grade of the at least one open job position.

6. The method of claim 1, further comprising determining geographic location proximity of an employee to a location of the at least one open job position and providing the notification to the employee that is within a certain proximity to the at least one open job position.

7. The method of claim 1, further comprising pre-scanning availability and setting up meetings between the qualified candidate and a hiring manager.

8. The method of claim 1, further comprising identifying skill gaps between an employee of the at least one open position and requirements for the at least one open position.

9. The method of claim 8, further comprising providing links to available and approved on-demand learning platforms for the employee to find courses to upskill or reskill.

10. The method of claim 1, further comprising automatically creating a new open position with job requirements for backfilling of a job which has been vacated by an employee that has accepted the at least one new open position.

11. A computer program product comprising one or more computer readable storage media having program instructions collectively stored on the one or more computer readable storage media, the program instructions executable to:
extract employee data from disparate internal systems of an organization including at least current pay grade;
obtain posted, open positions within an organization including pay grade of the posted, open positions;
compare the extracted employee data to the posted, open positions to determine which employees qualify for any of the posted, open positions, including which employees have a pay grade that is at or below the pay grade of the posted, open positions;
identify an employee who is qualified for at least one of the posted, open positions, and who has a pay grade at or below the pay grade of the at least one of the posted, open positions;
notify the identified employee that they qualify for the at least one of the posted, open positions; and
set up an interview with at least one of the identified employee and an individual that posted the open position by pre-scanning their calendars.

12. The computer program product of claim 11, wherein the comparing of the extracted employee data to the posted, open positions includes comparing location of the employee to the posted, open position and job requirements to skills of the employee.

13. The computer program product of claim 11, further comprising comparing employee driven information to the posted, open positions and when a match is found, providing the notification to the employee.

14. The computer program product of claim 11, further comprising automatically updating at least one of the disparate internal systems with employee information of an employee that transited into the posted, open position.

15. The computer program product of claim 11, further comprising providing links to available on-demand learning platforms for an interested employee to find courses to upskill or reskill that have skill gaps to at least one of the posted, open positions.

16. The computer program product of claim 11, further comprising automatically creating a new open position with job requirements for backfilling of a job which has been vacated by a candidate that has accepted one of the posted, open positions.

17. A system comprising:
an employee driven talent activation module, the employee driven talent activation module includes employee entered information comprising aspirations or goals of the employee and skill sets of the employee; and
a talent acquisition module that extracts and aggregates employee information and job postings from disparate systems within an organization including the employee driven talent activation module, the talent acquisition module includes a processor, a computer readable memory, one or more computer readable storage media, and program instructions collectively stored on the one or more computer readable storage media, the program instructions executable to determine which employees are qualified candidates to fill an open position based on a comparison between the employee information and the job postings and to provide a notification to the qualified candidates about the open position.

18. The system of claim 17, wherein the talent acquisition module compares pay scale, location, aspirations of the employee, and skill set to the job postings and selects employees that meet the qualifications of the open position and which are at a pay grade at or below the open position.

19. The system of claim 17, wherein the disparate systems include human resources system, payroll system, recruitment system and benefits system.

20. The system of claim 17, wherein the talent acquisition module uses machine learning and/or neutral networking to data mine the disparate systems to determine which employees are qualified for job positions and provides a list of candidates to a manager of the list of candidates.
